(19) United States
(12) Patent Application Publication
(10) Pub. No.: US 2011/0084953 A1
(43) Pub. Date: Apr. 14, 2011

(54) ORGANIC LIGHT EMITTING DISPLAY HAVING A POWER SAVING MECHANISM

(76) Inventors: Chia-Yu Lee, Hsin-Chu (TW); Tze-Chien Tsai, Hsin-Chu (TW)

(21) Appl. No.: 12/694,278

(22) Filed: Jan. 27, 2010

(30) Foreign Application Priority Data
Oct. 12, 2009 (TW) 098134492

(51) Int. Cl. G06F 3/038

(52) U.S. Cl. 345/212; 345/82

(57) ABSTRACT

An organic light emitting display having a power saving mechanism includes a first power module for generating a first power voltage, a second power module for generating a second power voltage, a gate driving circuit for generating a scan signal, a data driving circuit for generating a data signal, a pixel circuit, a ripple detection unit and a processing unit. The ripple detection unit detects the ripple of the first power voltage for generating a detection voltage. The processing unit generates a power-saving control signal according to the detection voltage. The pixel circuit employs the scan and data signals to control a light-emitting driving operation based on the voltage difference between the first and second power voltages. When the power-saving control signal is greater than a threshold, the first power module adjusts the first power voltage for reducing the voltage difference so as to save power consumption.

### BACKGROUND OF THE INVENTION

1. Field of the Invention

The present invention relates to an organic light emitting display, and more particularly, to an organic light emitting display having a power saving mechanism.

2. Description of the Prior Art

Because flat panel displays (FPDs) have advantages of thin appearance, low power consumption, and low radiation, various kinds of flat panel displays have been developed and widely applied in a variety of electronic products such as computer monitors, mobile phones, personal digital assistants (PDAs), or flat panel televisions. Among them, active matrix organic light emitting displays (AMOLEDs) have gained more and more attention due to further advantages of self-emitting light source, high brightness, high emission rate, high contrast, fast reaction, wide viewing angle, and extensive range of working temperature.

FIG. 1 is a structural diagram schematically showing a prior-art active matrix organic light emitting display 100. As shown in FIG. 1, the active matrix organic light emitting display 100 comprises a gate driving circuit 110, a data driving circuit 120, a plurality of pixel circuits 150, and a power unit 160. Each pixel circuit 150 includes a first transistor 151, a second transistor 152, a storage capacitor 153, and an organic light emitting diode 154. The power unit 160 is employed to provide a first power voltage Vdd and a second power voltage Vss furnished to each pixel circuit 150. The gate driving circuit 110 and the data driving circuit 120 are utilized for providing plural scan signals and plural data signals respectively. Each pixel circuit 150 employs corresponding scan and data signals to control the light-emitting driving operation of one organic light emitting diode 154 based on the voltage difference between the first power voltage Vdd and the second power voltage Vss. However, since the organic light emitting diodes 154 are current-driven devices, the power unit 160 is required to provide large currents to drive the organic light emitting diodes 154 when the active matrix organic light emitting display 100 is displaying high-brightness images, which is likely to cause high power consumption and increase panel temperature, resulting in shorter panel lifetime.

### SUMMARY OF THE INVENTION

In accordance with an embodiment of the present invention, an organic light emitting display having a power saving mechanism is disclosed. The organic light emitting display comprises a gate driving circuit for providing a scan signal, a data driving circuit for providing a data signal, a scan line, a data line, a first power module, a second power module, a pixel circuit, a first power line, a second power line, a ripple detection unit, a switch, and a processing unit.

The scan line, electrically connected to the gate driving circuit, is utilized for delivering the scan signal. The data line, electrically connected to the data driving circuit, is utilized for delivering the data signal. The first power module is employed to generate a first power voltage. The second power module is employed to generate a second power voltage. The voltage difference between the first power voltage and the second power voltage is greater than zero. The pixel circuit, electrically connected to the scan line, the data line, the first power module and the second power module, employs the scan signal and the data signal to control a light-emitting driving operation based on the voltage difference. The first power line, electrically connected to the pixel circuit and the first power module, is utilized for furnishing the first power voltage to the pixel circuit. The second power line, electrically connected to the pixel circuit and the second power module, is utilized for furnishing the second power voltage to the pixel circuit. The ripple detection unit is put in use for generating a detection voltage through detecting a ripple voltage of the first power voltage. The switch comprising a first end electrically connected to the first power line, a second end electrically connected to the ripple detection unit, and a control end for receiving a switch control signal. The processing unit, electrically connected to the ripple detection unit, the switch and the first power module, is utilized for providing the switch control signal to the switch. Also, the processing unit employs the detection voltage to generate a power-saving control signal forwarded to the first power module. And the first power module is then capable of reducing the voltage difference according to the power-saving control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural diagram schematically showing a prior-art active matrix organic light emitting display.

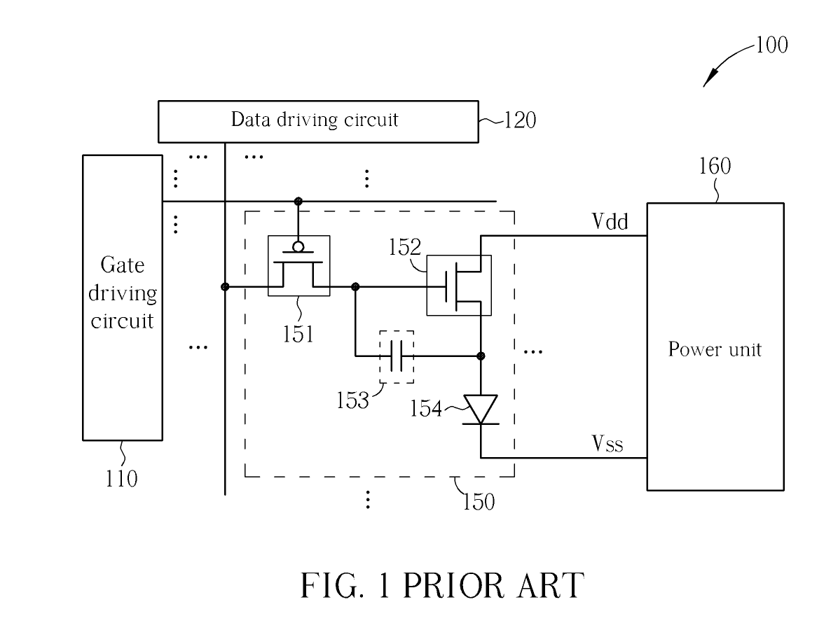

FIG. 2 is a structural diagram schematically showing an organic light emitting display in accordance with a first embodiment of the present invention.

FIG. 3 is a circuit diagram schematically illustrating a preferred embodiment of the first power module shown in FIG. 2.

FIG. 4 is a structural diagram schematically showing an organic light emitting display in accordance with a second embodiment of the present invention.

FIG. 5 is a circuit diagram schematically illustrating a preferred embodiment of the first power module shown in FIG. 4.

### DETAILED DESCRIPTION

Hereinafter, preferred embodiments of the present invention will be described in detail with reference to the accompanying drawings. Here, it is to be noted that the present invention is not limited thereto.

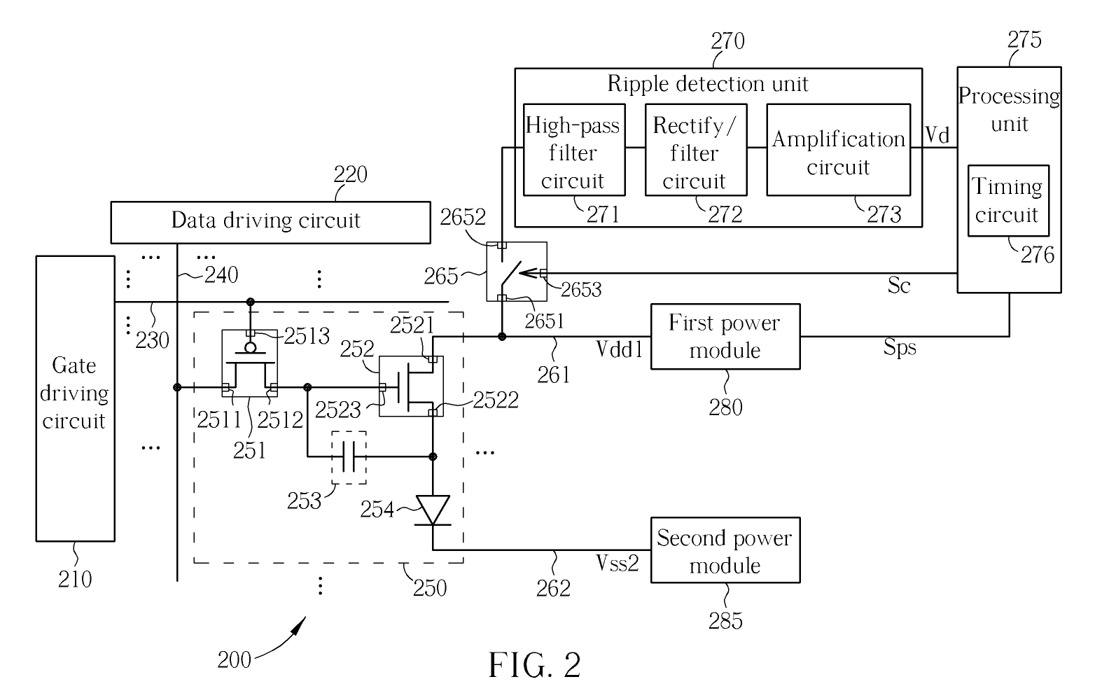

FIG. 2 is a structural diagram schematically showing an organic light emitting display 200 in accordance with a first embodiment of the present invention. As shown in FIG. 2, the organic light emitting display 200 comprises a gate driving circuit 210, a data driving circuit 220, a plurality of scan lines 230, a plurality of data lines 240, a plurality of pixel circuits 250, a ripple detection unit 270, a processing unit 275, a first power line 261, a second power line 262, a switch 265, a first power module 280, and a second power module 285. The first power module 280 and the second power module 285 are employed respectively to provide a first power voltage Vdd1 and a second power voltage Vss2 less than the first power voltage Vdd1. The first power voltage Vdd1 is furnished to each pixel circuit 250 via the first power line 261. The second power voltage Vss2 is furnished to each pixel circuit 250 via the second power line 262. The gate driving circuit 210 is utilized for providing plural scan signals furnished to the pixel circuits 250 via the scan lines 230. The data driving circuit 220 is utilized for providing plural data signals furnished to the pixel circuits 250 via the data lines 240. Each pixel circuit 250 comprises a first transistor 251, a second transistor 252, a storage capacitor 253, and an organic light emitting diode 254. The first transistor 251 is a thin film transistor or a field effect transistor. The second transistor 252 is an N-type thin film transistor or an N-type field effect transistor.

The first transistor 251 comprises a first end 2511 electrically connected to a corresponding data line 240, a gate end 2513 electrically connected to a corresponding scan line 230, and a second end 2512. The second transistor 252 comprises a first end (drain) 2521 electrically connected to the first power line 261, a gate end 2523 electrically connected to the second end 2512 of the first transistor 251, and a second end (source) 2522 electrically connected to the organic light emitting diode 254. The storage capacitor 253 is electrically connected between the gate end 2523 and the second end 2522 of the second transistor 252. That is, the voltage across the storage capacitor 253 is the gate-source voltage drop of the second transistor 252. The current flowing through the second transistor 252 is then controlled by the voltage across the storage capacitor 253. The organic light emitting diode 254 comprises an anode electrically connected to the second end 2522 of the second transistor 252 and a cathode electrically connected to the second power line 262. The pixel circuit 250 employs corresponding scan and data signals to control the light-emitting driving operation of the organic light emitting diode 254 based on the voltage difference between the first power voltage Vdd1 and the second power voltage Vss2.

The switch 265 comprises a first end 2651 electrically connected to the first power line 261, a second end 2652 electrically connected to the ripple detection unit 270, and a control end 2653 electrically connected to the processing unit 275 for receiving a switch control signal Sc. The ripple detection unit 270 is put in use for generating a detection voltage Vd according to the ripple voltage of the first power voltage Vdd1. The ripple detection unit 270 comprises a high-pass filter circuit 271, a rectify/filter circuit 272, and an amplification circuit 273. The high-pass filter circuit 271 is employed to extract the ripple voltage of the first power voltage Vdd1. The rectify/filter circuit 272 performs a rectify/filter operation on the ripple voltage of the first power voltage Vdd1 for generating a dc voltage. The amplification circuit 273 amplifies the dc voltage for generating the detection voltage Vd. The processing unit 275 comprises a timing circuit 276 for counting a predetermined time. After the organic light emitting display 200 is powered, the processing unit 275 forwards the switch control signal Sc to turn on (close) the switch 265 for enabling a power-saving control operation of the organic light emitting display 200 at the predetermined time. When the switch 265 is turned on (closed), the processing unit 275 generates a power-saving control signal Sps according to the detection voltage Vd. And therefore the first power module 280 is able to set the first power voltage Vdd1 according to the power-saving control signal Sps. The power-saving control operation of the organic light emitting display 200 is detailed as the followings.

While the organic light emitting display 200 is displaying high-brightness images, the first power module 280 and the second power module 285 are required to provide large currents for driving the organic light emitting diodes 254, i.e. the first power module 280 and the second power module 285 are working under heavy load. For that reason, the ripple voltage of the first power voltage Vdd1 becomes larger and, in turn, the detection voltage Vd generated by the ripple detection unit 270 is greater. Based on the greater detection voltage Vd, the processing unit 275 generates the power-saving control signal Sps for driving the first power module 280 to output the first power voltage Vdd1′ having lower voltage. Accordingly, the voltage difference between the first power voltage Vdd1′ and the second power voltage Vss2 is reduced to save power consumption. It is noted that while the organic light emitting display 200 is displaying high-brightness images, the variation of the voltage difference has little effect on the driving current provided by the first driving module 280 and the second driving module 285 because the driving current approximates transistor saturation current. Furthermore, since the organic light emitting display 200 has characteristics of high brightness and high contrast, the brightness and contrast of the high-brightness images are not significantly affected by the little reduction of the driving current. The aforementioned high-brightness images can be judged by the power-saving control signal Sps. For instance, when the power-saving control signal Sps is greater than a threshold, the images illustrated by the organic light emitting display 200 can be judged to be high-brightness images, which correspond to the heavy load operation of the first power module 280 and the second power module 285.

In one embodiment, the first power module 280 employs the power-saving control signal Sps to continuously adjust the first power voltage Vdd1. In another embodiment, the first power module 280 employs the power-saving control signal Sps to periodically adjust the first power voltage Vdd1 and the timing circuit 276 is further used to count a signal updating time, i.e. the processing unit 275 updates the power-saving control signal Sps based on the signal updating time as an updating cycle. Besides, the power-saving control signal Sps can be an analog signal or a digital signal. If the power-saving control signal Sps is an analog signal, the first power module 280 lowers the first power voltage Vdd1 when the power-saving control signal Sps is greater than a threshold, and the reduction amount of the first power voltage Vdd1′ is fixed or proportional to a difference between the power-saving control signal Sps and the threshold. If the power-saving control signal Sps is a digital signal, the first power module 280 lowers the first power voltage Vdd1 when the power-saving control signal Sps indicates a power-saving enable state, and the reduction amount of the first power voltage Vdd1′ is fixed.

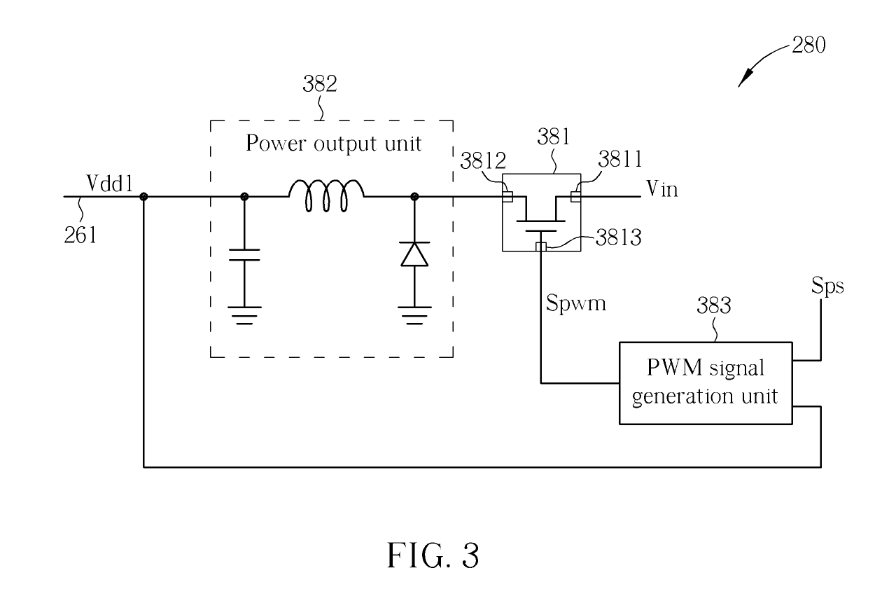

FIG. 3 is a circuit diagram schematically illustrating a preferred embodiment of the first power module 280 shown in FIG. 2. As shown in FIG. 3, the first power module 280 comprises a third transistor 381, a power output unit 382, and a pulse width modulation (PWM) signal generation unit 383. The third transistor 381 is a thin film transistor or a field effect transistor. The third transistor 381 comprises a first end 3811 for receiving a dc input voltage Vin, a gate end 3813 electrically connected to the PWM signal generation unit 383 for receiving a PWM signal Spwm, and a second end 3812 electrically connected to the power output unit 382. The third transistor 381 is utilized for furnishing the dc input voltage Vin into the power output unit 382 periodically according to the PWM signal Spwm. The power output unit 382, electrically connected between the first power line 261 and the third transistor 381, is put in use for converting the dc input voltage Vin periodically received into the first power voltage Vdd1. The internal circuit of the power output unit 382 is a prior-art circuit comprising components such as a diode, an inductor and a capacitor shown in FIG. 3.

The PWM signal generation unit 383, electrically connected to the first power line 261, the gate end 3813 of the third transistor 381 and the processing unit 275, is employed to generate the PWM signal Spwm having desired duty cycle according to the first power voltage Vdd1 and the power-saving control signal Sps. When the ripple voltage of the first power voltage Vdd1 is not greater than a threshold voltage, the PWM signal generation unit 383 generates the PWM signal Spwm only based on the first power voltage Vdd1. And the voltage difference between the first power voltage Vdd1 and the second power voltage Vss2 is regulated to be a first voltage difference. When the ripple voltage of the first power voltage Vdd1 is greater than the threshold voltage, the PWM signal generation unit 383 generates the PWM signal Spwm based on both the first power voltage Vdd1 and the power-saving control signal Sps. And the voltage difference between the first power voltage Vdd1′ and the second power voltage Vss2 is regulated to be a second voltage difference less than the first voltage difference.

To sum up, the organic light emitting display 200 employs the ripple voltage of the first power voltage Vdd1 to judge whether the images currently displayed are high-brightness images. And the operation of the first power module 280 is controlled to lower the first power voltage Vdd1 while displaying high-brightness images, for saving power consumption and reducing panel temperature to extend panel lifetime.

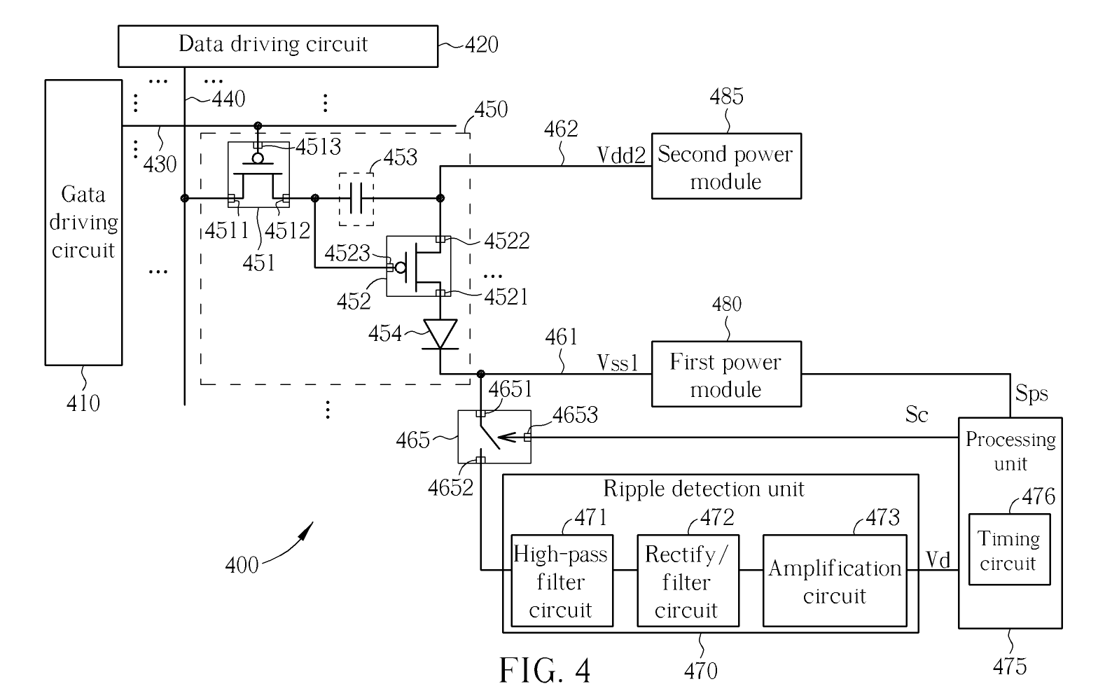

FIG. 4 is a structural diagram schematically showing an organic light emitting display 400 in accordance with a second embodiment of the present invention. As shown in FIG. 4, the organic light emitting display 400 comprises a gate driving circuit 410, a data driving circuit 420, a plurality of scan lines 430, a plurality of data lines 440, a plurality of pixel circuits 450, a ripple detection unit 470, a processing unit 475, a first power line 461, a second power line 462, a switch 465, a first power module 480, and a second power module 485. The first power module 480 and the second power module 485 are employed respectively to provide a first power voltage Vss1 and a second power voltage Vdd2 greater than the first power voltage Vss1. The first power voltage Vss1 is furnished to each pixel circuit 450 via the first power line 461. The second power voltage Vdd2 is furnished to each pixel circuit 450 via the second power line 462. The gate driving circuit 410 is utilized for providing plural scan signals furnished to the pixel circuits 450 via the scan lines 430. The data driving circuit 420 is utilized for providing plural data signals furnished to the pixel circuits 450 via the data lines 440. Each pixel circuit 450 comprises a first transistor 451, a second transistor 452, a storage capacitor 453, and an organic light emitting diode 454. The first transistor 451 is a thin film transistor or a field effect transistor. The second transistor 452 is a P-type thin film transistor or a P-type field effect transistor.

The first transistor 451 comprises a first end 4511 electrically connected to a corresponding data line 440, a gate end 4513 electrically connected to a corresponding scan line 430, and a second end 4512. The second transistor 452 comprises a first end (drain) 4521 electrically connected to the organic light emitting diode 454, a second end (source) 4522 electrically connected to the second power line 462, and a gate end 4523 electrically connected to the second end 4512 of the first transistor 451. The storage capacitor 453 is electrically connected between the gate end 4523 and the second end 4522 of the second transistor 452. That is, the voltage across the storage capacitor 453 is the gate-source voltage drop of the second transistor 452. The current flowing through the second transistor 452 is then controlled by the voltage across the storage capacitor 453. The organic light emitting diode 454 comprises an anode electrically connected to the first end 4521 of the second transistor 452 and a cathode electrically connected to the first power line 461. The pixel circuit 450 employs corresponding scan and data signals to control the light-emitting driving operation of the organic light emitting diode 454 based on the voltage difference between the first power voltage Vss1 and the second power voltage Vdd2.

The switch 465 comprises a first end 4651 electrically connected to the first power line 461, a second end 4652 electrically connected to the ripple detection unit 470, and a control end 4653 electrically connected to the processing unit 475 for receiving a switch control signal Sc. The ripple detection unit 470 is put in use for generating a detection voltage Vd according to the ripple voltage of the first power voltage Vss1. The ripple detection unit 470 comprises a high-pass filter circuit 471, a rectify/filter circuit 472, and an amplification circuit 473. The high-pass filter circuit 471 is employed to extract the ripple voltage of the first power voltage Vss1. The rectify/filter circuit 472 performs a rectify/filter operation on the ripple voltage of the first power voltage Vss1 for generating a dc voltage. The amplification circuit 473 amplifies the dc voltage for generating the detection voltage Vd. The processing unit 475 comprises a timing circuit 476 for counting a predetermined time. After the organic light emitting display 400 is powered, the processing unit 475 forwards the switch control signal Sc to turn on the switch 465 for enabling a power-saving control operation of the organic light emitting display 400 at the predetermined time. When the switch 465 is turned on, the processing unit 475 generates a power-saving control signal Sps according to the detection voltage Vd. And therefore the first power module 480 is able to set the first power voltage Vss1 according to the power-saving control signal Sps. The power-saving control operation of the organic light emitting display 400 is detailed as the followings.

While the organic light emitting display 400 is displaying high-brightness images, the first power module 480 and the second power module 485 are required to provide large currents for driving the organic light emitting diodes 454, i.e. the first power module 480 and the second power module 485 are working under heavy load. For that reason, the ripple voltage of the first power voltage Vss1 becomes larger and, in turn, the detection voltage Vd generated by the ripple detection unit 470 is greater. Based on the greater detection voltage Vd, the processing unit 475 generates the power-saving control signal Sps for driving the first power module 480 to output the first power voltage Vss1′ having higher voltage. Accordingly, the voltage difference between the first power voltage Vss1′ and the second power voltage Vdd2 is reduced to save power consumption without significantly affecting the brightness and contrast of images displayed on the organic light emitting display 400. Similarly, the aforementioned high-brightness images can be judged by the power-saving control signal Sps.

In one embodiment, the first power module 480 employs the power-saving control signal Sps to continuously adjust the first power voltage Vss1. In another embodiment, the first power module 480 employs the power-saving control signal Sps to periodically adjust the first power voltage Vss1 and the timing circuit 476 is further used to count a signal updating time, i.e. the processing unit 475 updates the power-saving control signal Sps based on the signal updating time as an updating cycle. Besides, the power-saving control signal Sps can be an analog signal or a digital signal. If the power-saving control signal Sps is an analog signal, the first power module 480 raises the first power voltage Vss1′ when the power-saving control signal Sps is greater than a threshold, and the increase amount of the first power voltage Vss1′ is fixed or proportional to a difference between the power-saving control signal Sps and the threshold. If the power-saving control signal Sps is a digital signal, the first power module 480 raises the first power voltage Vss1′ when the power-saving control signal Sps indicates a power-saving enable state, and the increase amount of the first power voltage Vss1′ is fixed.

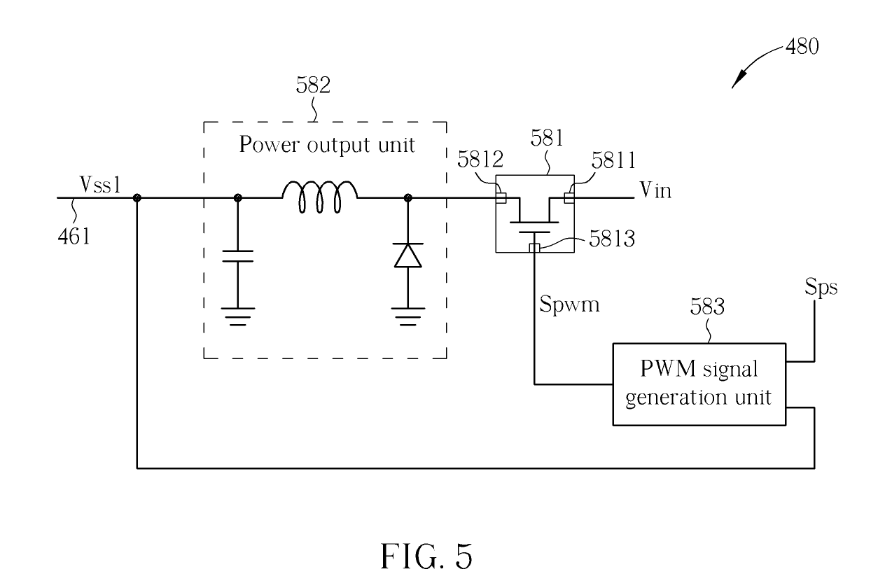

FIG. 5 is a circuit diagram schematically illustrating a preferred embodiment of the first power module 480 shown in FIG. 4. As shown in FIG. 5, the first power module 480 comprises a third transistor 581, a power output unit 582, and a PWM signal generation unit 583. The third transistor 581 is a thin film transistor or a field effect transistor. The third transistor 581 comprises a first end 5811 for receiving a dc input voltage Vin, a gate end 5813 electrically connected to the PWM signal generation unit 583 for receiving a PWM signal Spwm, and a second end 5812 electrically connected to the power output unit 582. The third transistor 581 is utilized for furnishing the dc input voltage Vin into the power output unit 582 periodically according to the PWM signal Spwm. The power output unit 582, electrically connected between the first power line 461 and the third transistor 581, is put in use for converting the dc input voltage Vin periodically received into the first power voltage Vss1. The internal circuit of the power output unit 582 is a prior-art circuit comprising components such as a diode, an inductor and a capacitor shown in FIG. 5.

The PWM signal generation unit 583, electrically connected to the first power line 461, the gate end 5813 of the third transistor 581 and the processing unit 475, is employed to generate the PWM signal Spwm having desired duty cycle according to the first power voltage Vss1 and the power-saving control signal Sps. When the ripple voltage of the first power voltage Vss1 is not greater than a threshold voltage, the PWM signal generation unit 583 generates the PWM signal Spwm only based on the first power voltage Vss1. And the voltage difference between the first power voltage Vss1 and the second power voltage Vdd2 is regulated to be a first voltage difference. When the ripple voltage of the first power voltage Vss1 is greater than the threshold voltage, the PWM signal generation unit 583 generates the PWM signal Spwm based on both the first power voltage Vss1 and the power-saving control signal Sps. And the voltage difference between the first power voltage Vss1′ and the second power voltage Vdd2 is regulated to be a second voltage difference less than the first voltage difference.

To sum up, the organic light emitting display 400 employs the ripple voltage of the first power voltage Vss1 to judge whether the images currently displayed are high-brightness images. And the operation of the first power module 480 is controlled to raise the first power voltage Vss1 while displaying high-brightness images, for saving power consumption and reducing panel temperature to extend panel lifetime.

In conclusion, the organic light emitting display of the present invention employs the ripple voltage of either high power voltage or low power voltage to judge whether the images currently displayed are high-brightness images. And the operation of one corresponding power module is controlled to lower the voltage difference between two power voltages while displaying high-brightness images, for saving power consumption and reducing panel temperature to extend panel lifetime.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. An organic light emitting display, comprising:
a gate driving circuit for providing a scan signal;
a data driving circuit for providing a data signal;
a scan line, electrically connected to the gate driving circuit, for delivering the scan signal;
a data line, electrically connected to the data driving circuit, for delivering the data signal;
a first power module for generating a first power voltage;
a second power module for generating a second power voltage, wherein a voltage difference between the first power voltage and the second power voltage is greater than zero;
a pixel circuit, electrically connected to the scan line, the data line, the first power module and the second power module, for employing the scan signal and the data signal to control a light-emitting driving operation based on the voltage difference;
a first power line, electrically connected to the pixel circuit and the first power module, for furnishing the first power voltage to the pixel circuit;
a second power line, electrically connected to the pixel circuit and the second power module, for furnishing the second power voltage to the pixel circuit;
a ripple detection unit for generating a detection voltage through detecting a ripple voltage of the first power voltage;
a switch comprising a first end electrically connected to the first power line, a second end electrically connected to the ripple detection unit, and a control end for receiving a switch control signal; and
a processing unit, electrically connected to the ripple detection unit, the switch and the first power module, for employing the detection voltage to generate a power-saving control signal forwarded to the first power module, and for providing the switch control signal;
wherein the first power module reduces the voltage difference according to the power-saving control signal.

2. The organic light emitting display of claim 1, wherein the pixel circuit comprises:
a first transistor comprising a first end electrically connected to the data line, a gate end electrically connected to the scan line, and a second end;
a second transistor comprising a first end electrically connected to the first power line for receiving the first power voltage, a gate end electrically connected to the second end of the first transistor, and a second end;
a storage capacitor electrically connected between the gate and second ends of the second transistor; and
an organic light emitting diode comprising an anode electrically connected to the second end of the second transistor and a cathode electrically connected to the second power line for receiving the second power voltage;
wherein the first power voltage is greater than the second power voltage.

3. The organic light emitting display of claim 2, wherein the first transistor is a thin film transistor or a field effect transistor.

4. The organic light emitting display of claim 2, wherein the second transistor is an N-type thin film transistor or an N-type field effect transistor.

5. The organic light emitting display of claim 2, wherein the first power module lowers the first power voltage for reducing the voltage difference according to the power-saving control signal when the power-saving control signal is greater than a threshold.

6. The organic light emitting display of claim 1, wherein the pixel circuit comprises:
a first transistor comprising a first end electrically connected to the data line, a gate end electrically connected to the scan line, and a second end;
a second transistor comprising a first end, a second end electrically connected to the second power line for receiving the second power voltage, and a gate end electrically connected to the second end of the first transistor;
a storage capacitor electrically connected between the gate and second ends of the second transistor; and
an organic light emitting diode comprising an anode electrically connected to the first end of the second transistor and a cathode electrically connected to the first power line for receiving the first power voltage;
wherein the first power voltage is less than the second power voltage.

7. The organic light emitting display of claim 6, wherein the first transistor is a thin film transistor or a field effect transistor.

8. The organic light emitting display of claim 6, wherein the second transistor is a P-type thin film transistor or a P-type field effect transistor.

9. The organic light emitting display of claim 6, wherein the first power module raises the first power voltage for reducing the voltage difference according to the power-saving control signal when the power-saving control signal is greater than a threshold.

10. The organic light emitting display of claim 1, wherein the power-saving control signal generated by the processing unit is an analog signal.

11. The organic light emitting display of claim 10, wherein the first power module reduces the voltage difference according to the power-saving control signal when the power-saving control signal is greater than a threshold, and a reduction amount of the voltage difference is proportional to a difference between the power-saving control signal and the threshold.

12. The organic light emitting display of claim 10, wherein the first power module reduces the voltage difference according to the power-saving control signal when the power-saving control signal is greater than a threshold, and a reduction amount of the voltage difference is fixed.

13. The organic light emitting display of claim 1, wherein the power-saving control signal generated by the processing unit is a digital signal.

14. The organic light emitting display of claim 13, wherein the first power module reduces the voltage difference according to the power-saving control signal when the power-saving control signal indicates a power-saving enable state, and a reduction amount of the voltage difference is fixed.

15. The organic light emitting display of claim 1, wherein the ripple detection unit comprises:
a high-pass filter circuit, electrically connected to the switch, for extracting the ripple voltage of the first power voltage;
a rectify/filter circuit, electrically connected to the high-pass filter circuit, for generating a dc voltage through performing a rectify/filter operation on the ripple voltage of the first power voltage; and
an amplification circuit, electrically connected to the rectify/filter circuit, for amplifying the dc voltage to generate the detection voltage.

16. The organic light emitting display of claim 1, wherein the processing unit comprises:
a timing circuit for counting a predetermined time;
wherein the processing unit forwards the switch control signal to turn on the switch at the predetermined time after the organic light emitting display is powered.

17. The organic light emitting display of claim 16, wherein the timing circuit is further employed to count a signal updating time, and the processing unit updates the power-saving control signal based on the signal updating time as an updating cycle.

18. The organic light emitting display of claim 1, wherein the first power module comprises:
a transistor comprising a first end for receiving a dc input voltage, a gate end for receiving a pulse width modulation signal, and a second end;
a power output unit, electrically connected to the first power line and the second end of the transistor, for outputting the first power voltage; and
a pulse width modulation signal generation unit, electrically connected to the first power line, the gate end of the transistor and the processing unit, for generating the pulse width modulation signal according to the first power voltage and the power-saving control signal.

19. The organic light emitting display of claim 18, wherein the pulse width modulation signal generation unit generates the pulse width modulation signal according to the first power voltage when the ripple voltage of the first power voltage is not greater than a threshold voltage, and the voltage difference is regulated to be a first voltage difference according to the pulse width modulation signal.

20. The organic light emitting display of claim 19, wherein the pulse width modulation signal generation unit generates the pulse width modulation signal according to the first power voltage and the power-saving control signal when the ripple voltage of the first power voltage is greater than the threshold voltage, and the voltage difference is regulated to be a second voltage difference according to the pulse width modulation signal, wherein the second voltage difference is less than the first voltage difference.
